(19) United States
(12) Patent Application Publication
(10) Pub. No.: US 2023/0161950 A1
(43) Pub. Date: May 25, 2023

(54) PLATFORM FOR MULTI-PARTY LEGAL SERVICES AND AUTOMATED FULFILLMENT

(71) Applicant: Net Law Group, Inc., Louisville, KY (US)

(72) Inventors: Alex J. Hargrove, Louisville, KY (US); Zlatko Zelimanovic Pazanin, Louisville, KY (US)

(21) Appl. No.: 18/076,022

(22) Filed: Dec. 6, 2022

Related U.S. Application Data
(63) Continuation-in-part of application No. 17/146,131, filed on Jan. 11, 2021, now Pat. No. 11,537,684.
(60) Provisional application No. 63/286,332, filed on Dec. 6, 2021.
(60) Provisional application No. 62/959,507, filed on Jan. 10, 2020.

(51) Int. Cl. G06F 40/166; G06Q 50/18

(52) U.S. Cl. CPC G06F 40/166; G06Q 50/186

(57) ABSTRACT

A computing system environment method for data management for automated document creation includes steps of defining one or more data entities and associating the one or more data entities with unique identifiers in storage. At least one relationship is defined between the one or more defined data entities. The one or more defined data entities are into one or more guides. Filtered views of the one or more guides are provided according to the one or more defined relationships.

This application is a continuation-in-part application claiming the benefit of priority in U.S. Pat. Appl. S.N. 17/146,131 filed on Jan. 11, 2021, and also claims the benefit of priority in U.S. Provisional Pat. Appl. S.N. 63/286,332 filed on Dec. 6, 2021 and S.N. 62/959,507 filed on Jan. 10, 2020, the entire disclosures of each of which are incorporated herein by reference.

### TECHNICAL FIELD

The present disclosure relates to cloud-based provision of legal services requiring the input and participation of differing professionals having particular expertise in various facets of the task that is the subject of the legal services. The disclosure relates in particular to a cloud-based service which allows access to/integration of data relevant to the legal services being provided, wherein such data is held/stored by multiple of the differing professionals and may be in multiple different formats.

### BACKGROUND

The process of creating legal documents involves multiple parties and multiple steps. Most of the work is typically done by attorneys, but there is often collaboration from other professionals/paraprofessionals, such as financial advisors and paralegals.

For example, estate plans are created in the context of an engagement. An engagement defines the scope of estate planning and the limits of the professional’s (namely, the attorney’s) duty in procuring it. The current state of the art for estate planning is highly fragmented with disparate non-cooperative and non-integrated systems and independent actors. Different steps of the engagement are handled by different actors, who may use very different technology. An advisor, for example, may refer clients to multiple attorneys based on geography. Each of those attorneys will, in turn, have their own client management systems, methods of intake, document creation, and fulfillment (printing/execution). This disparity in systems and methods creates inconsistency and may result in delays, errors, and need for multiple reviews and revisions during the process.

The present disclosure solves these problems by providing systems and methods for making data held or stored by various actors selectively accessible to multiple parties involved in the process.

### SUMMARY

In accordance with the purposes and benefits described herein, in one aspect is provided a method for data management for automated document creation, comprising steps of defining one or more data entities and associating the one or more data entities with unique identifiers in storage. At least one relationship is defined between the one or more defined data entities. The one or more defined data entities are imported into one or more guides. At least one additional relationship may be defined between the one or more defined data entities in embodiments. Filtered views of the one or more guides are provided according to the one or more defined relationships.

The method may include defining a hierarchy for the at least one defined relationship. The defining one or more data entities may include selecting variables from the group consisting of unique system names, entities from whom to inherit properties or assets, and owned properties. Supported data types for the one or more defined data entities may be selected from the group consisting of text, alphanumerical, currency, date, time, datetime, Boolean, globally unique identifier, entity object with inheritance and multiple sub-properties, function data with dynamic computation, binary arrays of bytes, and mapped data.

In embodiments, the one or more entity instances may be defined by selecting variables from the group consisting of a storage-generated globally unique instance identifier, an entity type name, a definition for authorized access to the defined entity instance, and a defined property value for the entity. The defined property value may be selected from one or more of first name, date of birth, and address.

In embodiments, a structure of the one or more guides may be defined by selecting variables from the group consisting of a unique system name, a title, a description of the document, a model defining inherited or owned properties, and a list of principals assigned a specific role. One or more guide instances may be defined by selecting variables from the group consisting of a storage-generated globally unique guide identifier, a guide name, a definition for authorized access to the defined guide instance, and a definition for authorized access to the principals assigned a specific role.

The step of providing filtered views of the one or more guides according to the one or more defined relationships may include selectively restricting or permitting access to one or more of the one or more guides by a particular principal assigned a particular role during an engagement timeline.

In the following description, there are shown and described several preferred embodiments of the described methods and systems. As it should be realized, the methods and systems are capable of other, different embodiments and their several details are capable of modification in various, obvious aspects all without departing from the methods and systems as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the described methods and systems for providing an interactive interview process to acquire data for document creation, and together with the description serves to explain certain principles thereof. In the drawing figures:

FIG. 1 schematically shows a relationship schema among various entities according to the present disclosure.

FIG. 2 shows an engagement timeline for a process of creating a legal document according to the present disclosure.

FIG. 3 schematically shows a data filtering process according to the present disclosure.

FIG. 4 illustrates in flow chart form a process for data filtering and preparing a legal document according to the present disclosure.

Reference will now be made in detail to the present preferred embodiments of the described systems and methods, examples of which are illustrated in the accompanying drawing figures.

### DETAILED DESCRIPTION

Any citations or other references included or referred to in this application form a part of the disclosure and are incorporated herein in their entirety by reference. It will be appreciated that the embodiments described in this patent application are an illustration of one of the modes best suited to carry out the invention. The invention is capable of other different embodiments, and its several details are capable of modification in various, obvious aspects all without departing from the invention. Accordingly, the descriptions provided herein will be regarded as illustrative in nature and not as restrictive.

At a high level, when an advisor refers a client to an attorney for estate planning or other legal services, the attorney typically requires the client to complete an intake form. This intake form may be digital or require pen/paper. In any case, the process is typically distinct and individual to the attorney. For each attorney to whom the advisor refers clients, the lawyer will have his or her own method of collecting this information.

Oftentimes, though, the financial advisor will already have in an existing system much of the data needed to generate the documents. The presently described platform liberates that data by providing a translation layer that formats the data and makes it usable for multiple parties who need to collaborate on the client’s legal matter. It will be appreciated that while the present disclosure presents the subject matter in the context of estate planning, the skilled artisan will readily realize that the methods and systems described herein are equally applicable to other areas of law requiring collaborative effort from legal professionals, paraprofessionals, and other professionals.

By the presently described system, advisors can make their data available to the other parties in the engagement, allowing them to collaborate on that data in a unified environment. For the clients, this means very little data entry. The system takes the existing data and translates it into a format that can then be exposed to the client to augment or supplement, such as via a suitable interview form. In one possible embodiment, a suitable interview system is described in the present inventor’s U.S. Published Pat. Appl. No. 2021/0216600.

The formatted data can then be provided to a paralegal or other executive assistant to review, and to the attorney to tailor the ultimate legal documents. That data is further used in the fulfillment process, which is the last step in the engagement.

At each step in the process, the parties, identified below that step, play some role in “assembling” and/or “fulfilling” the clients ultimate estate plan. The presently described platform facilitates this process at various points, for example:
Where the Advisor provides, either through an integration with existing data or through manual entry of that data into an interview in a custom portal, basic data, like family members, demographics, addresses, and financial information about a client.
Where a Client, in turn, completes an interview, powered by that data, that lets the client think through and make certain decisions regarding their estate plan before meeting with the attorney.
Where an Attorney is finally able to generate the documents automatically through a combination of data provided from the advisor, inputs from the client, and further inputs from the attorney, all collected through “unified” web based forms.
Where a Fulfillment Service is able to then be notified and provided access, programmatically, to the documents with appropriate unique identifiers to complete the final steps of planning process.

In many legal services, original, physically signed and often notarized documents are required to be valid and enforceable by a court. This is particularly true in estate planning which places unique formalities around Wills & Trusts for reasons particular to the nature and function of those documents and obvious potentials for malfeasance and absure.

The presently described platform ensures that the physical original documents can be tracked as they are sent to the Client to execute, returned by the Client to the Fulfillment provider, stored in long-term, secure storage, and made available via the platform for the client or the client’s duly authorized agents, to request the return of said originals.

As one non-limiting example, presently the state of the art of fulfillment of estate plans varies widely among attorneys and law firms. This results in inefficiencies in drafting individualized estate plans similar to those overcome in the art of motor vehicle manufacture by Henry Ford’s assembly line. Rather than having one team do every possible job (which is the status quo), each person should have a role and the tools for that role.

While systems and methods exist for providing highly performant web forms that support near infinite complexity, existing low or no code editors suffer from certain limitations:
a) They cannot support the level of nesting and complex data types, such as entities, that may be required to drive document assembly workflows
b) They can support highly complex data types and nesting but at a performance cost that can be significant, often measured in multiples of seconds.
c) They can support highly complex data types and nesting but only in the context of a specific document assembly suite.

The presently disclosed methods and attendant systems facilitate this process through a myriad of services and integration points to deliver high quality legal services with minimal risk of error and maximum efficiency. Subject matter experts can create highly interactive web forms with virtually unlimited control over the data model using an easy drag-n-drop editor. A Data Engine then runs the forms with extremely low (< 20 millisecond) latency. Finally, a post-processing service formats the data into any required output format to allow for interoperability with virtually any document assembly system. An exemplary system for accomplishing these steps is described in U.S. Published Pat. Appl. S.N. 2021/0216600.

Specifically with regards to interoperability, moving highly nuanced document templates, particularly those with state specific permutations, and potential multi-party uses, into a new system can be impracticable for many businesses. The present disclosure overcomes this by allowing for near-unlimited data models and output formats and formatting. Subject matter experts working for a business are thus able to much more readily use a visual (no/low-code) editor to recreate their web forms without having to undertake the much more laborious (and almost always impracticable) step of recreating their nuanced document templates. This allows creating and rendering complex, highly performant web interviews by use of a low-code editor, and support interoperability with existing third-party document assembly systems. In one embodiment, a suitable web interview method and system is disclosed in U.S. Published Pat. Appl. No. 2021/0216600.

The above-described steps require interoperability features but also require the ability to provide confidentiality in the context of attorney-client interactions. The presently-described platform satisfies this need. For purposes of example the following discussion refers to legal documents in the context of trusts and estates planning. However, the skilled artisan will appreciate that other types of legal documents are contemplated and possible.

Various data types required for legal documents are supported, including without intending any limitation text, numerical, currency (numerical with currency symbols, for example “$” or non-US equivalents), date, time, datetime, Boolean, identification, globally unique identifier (guid), entity (object with inheritance and multiple sub-properties), computed data (functions with dynamic computation), binary (bytes array), map (not strongly typed key-value based storage), and others.

Entities are defined herein as complex data types or objects associated in storage with unique keys or identifiers. These are provided to support inheritance schemes which are not strictly cyclical relationships. Each entity is assigned unique properties (name, type, value, access) which can be of any of the above-listed data types.

In one possible embodiment, an entity definition structure may be established by the following variables:
Name - unique system name (ex. Person)
Inherits: [] - entities to inherit properties or assets from
Properties: [] - owned properties

A specific entity instance may be defined as:
@id - storage-generated guid
@type - entity type name
@definition - authorized access to entity definition
... other defined property values, for example: FirstName, date of birth (DOB), Address, and others

The presently described platform includes guides providing views of data entities as defined above, allowing data entry and modification. Each guide instance is associated with its own storage and can use other entities (principals) if so defined. Principals may participate in the platform if mentioned in a principals array as, for example, {name, entityTypeOrFilter, access:[r,w, r/w], default:bool}. One example for an estate settlor would be {settlor, Person, r/w, false}.

A guide definition structure is contemplated, in one embodiment including the following values:
Name - unique system name (for example, last-will)
Title
Description
Model:[] - inherited or own properties
Principals: [] - list of required external entities pretending to a specific role, e.g. beneficiary:Person, settlor:Person, etc.

A specific guide instance may be defined as:
@id - storage-generated guid
@type - guide name
@definition - authorized access to guide definition
@principals:{} - access to principal’s data
--- other guide specific values, for example Executor(s), AlternateExecutor(s), and others.

In turn, the described platform defines particular Entity relationships. That is, each entity of type “Person” may have an additionally defined relationship with other specified entities. In an embodiment the variable “relationship” is a directional entry, i.e. a {from, to, relationship} such as {Josh, Mary, spouse}. It is contemplated to provide certain relationship variables a hierarchical priority in the platform. One possible example is presented below in order of highest to lowest priority:
1) spouse, ex-spouse - marriage relationships
2) child, parent, ... - first degree family relationship
3) grand*, sibling - second degree family relationship
4) friend, other, advisor, ... - family unrelated

Relationships are also provided built-in assumptions to simplify data entry. In one possible example, relationship assumptions may be coded as:
x.$grandchildren = = x.$children.$children
x.$spouse = = x.$spouse.$spouse.$spouse
x.$stepchildren = = (x.$spouse.$children - x.$children)
x.$childrenOfPastRelationshiop = = (x$children - x.$spouse.$children)
x.$daughters = = x.$children[Gender= =female]

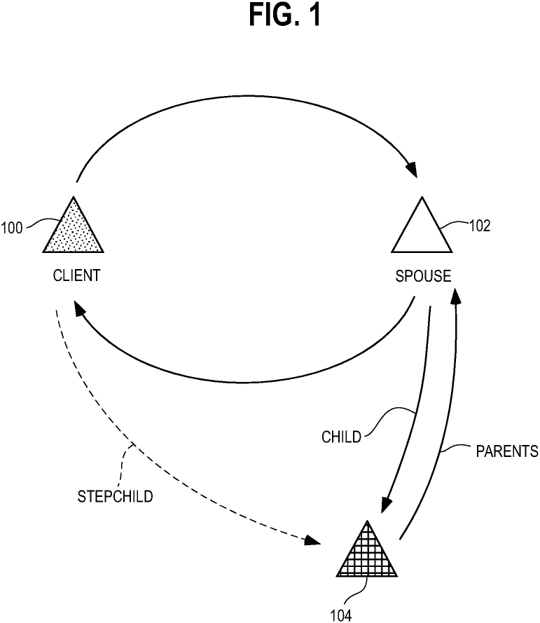

This may be depicted as shown in FIG. 1, wheren a starting point is a client 100 and other family members such as spouse 102 and children/stepchildren 104 (depending on relationship with client 100 and spouse 102) link to the client. In the depicted example of FIG. 1, a two-way spouse relationship and a one-way child relationship are defined, and the computed relationships are stepchild (to client 100) and parent (of spouse 102).

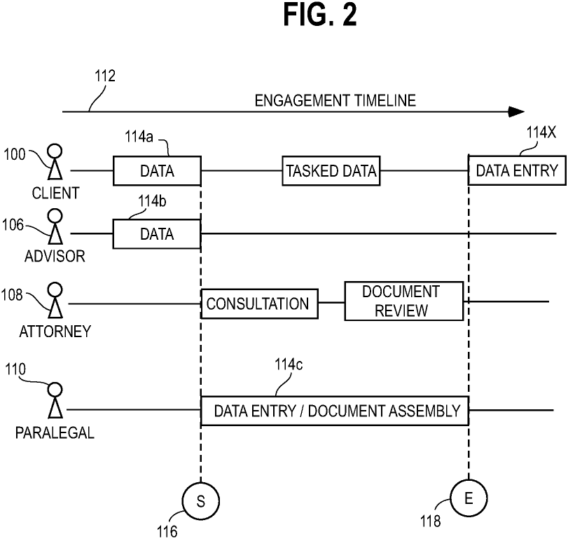

Collaborations of various parties in the platform in an engagement to eventually provide a legal document such as a will are depicted in FIG. 2. The depicted collaborators are client 100, advisor (for example financial advisor) 106, attorney 108, and paralegal 110 (typically in association with attorney 108). Each party/participant on the platform is part of the client 100 engagement in a specifically defined role which is also time-defined and which depends on the state and progress of the engagement timeline 112. Data entry and exchange access occur via specific guides 114 a, b, ..., x. In the depicted example, data obtained/stored by the client 100 and an advisor 106 relevant to the legal document to be created is entered into the platform by way of guides 114a, 114b. For example, the client 100 and the advisor 106 have stored data relating to assets, addresses, family members, non-family members, and others that may be relevant to the creation of an estate planning document such as a will.

A start point 116 is defined for participation of attorney 108/paralegal 110. At start point 116, both client 100 and advisor 106 lose data entry and modification access during the timeframe established for the curated process of attorney and paralegal data entry/modification (start point 116 to end point 118). Advisor 106 does not regain data entry and modification access. At end point 118, client 100 regains at least limited data modification access in accordance with any additional tasks required of the client to finalize the legal document.

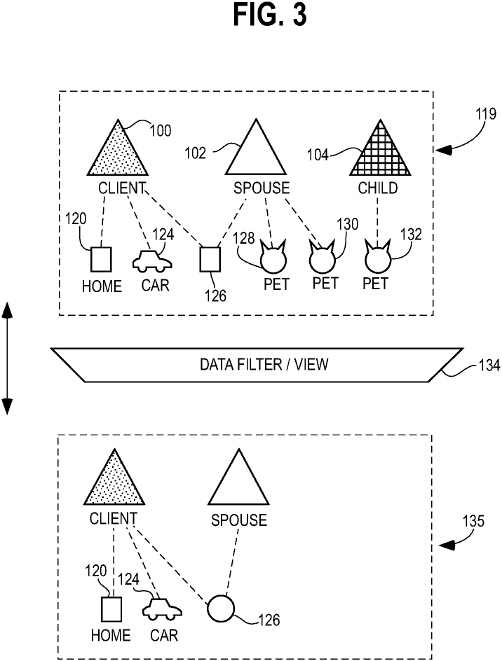

With reference to FIG. 3, the platform further includes data access filters which permit/proscribe access to particular data. Data related to various assets and items that may be joint property of client 100/spouse 102 or individually associated with one or the other of client 100/spouse 102 are entered via guides 114 at step 119. In the depicted example, data relating to home 120, car 124, other joint property 126, and various pets 128, 130, 132 are entered. Data filter 134 screens the data whereby only items which both client 100/spouse 102 are entitled to view at step 134/inherit upon the death of client 100 or spouse 102, for example home 120, car 124, and joint property 126. Other items specific to spouse 102.child 104 are not viewable at step 134.

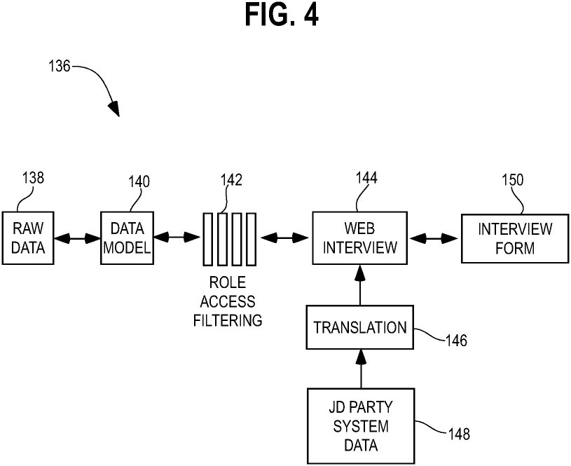

FIG. 4 illustrates in flow chart form a processing scheme 136 for providing and modifying/manipulating data from various participants as exemplified in FIGS. 1-3 for creation of a legal document such as a will. At step 138, client 100 data are stored in raw format by, e.g., client 100 and advisor 106 (not shown). As shown in FIG. 2, the data from step 138 enter the platform via one or more guides 114 specific to individual participants such as client 100/advisor 106. A data model is applied at step 140 to convert the data to a format usable by guides 114. Upon provision of data from client 100/advisor 106 (start point 116 of FIG. 2), the data are filtered based on participant role whereby only attorney 108/paralegal 110 are provided access and modification rights (see FIG. 2). At step 144, the filtered data are provided to a web interview platform such as that described in U.S. Published Appl. No. 2021/0216600.

Data originating from third party systems (step 148) are translated to a format usable by the web interview platform at translation step 146. This process is illustrated as unidirectional but as will be appreciated may be bi-directional if required. By “translation” it is meant one or more of:
Field mapping - linking data by name in the web interview platform and the third party system
Data formatting functions - making type and formatting changes where required
Validators - checking completeness of each data set
Event functions - handling pre-and post-operations of data preparation.

By these steps, translation bundles of data are provided that are specific to a particular system, are reusable, and are platform independent. Once the various data are provided to the interview platform at step 144, the platform generates a legal document at step 150 for final review by client 100 and attorney 108. This process is described in detail in U.S. Published Appl. No. 2021/0216600.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, the skilled artisan will readily appreciate that the described system is equally applicable to provision of legal services other than estate planning services that require collaborative efforts of various differing professionals.

The described embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. In a computing system environment, a method for data management for automated document creation, comprising:
defining one or more data entities;
associating the one or more data entities with unique identifiers in storage;
defining at least one relationship between the one or more defined data entities;
importing the one or more defined data entities into one or more guides; and
providing filtered views of the one or more guides according to the one or more defined relationships.

2. The method of claim 1, including defining a hierarchy for the at least one defined relationship.

3. The method of claim 1, wherein supported data types for the one or more defined data entities are selected from the group consisting of text, alphanumerical, currency, date, time, datetime, Boolean, globally unique identifier, entity object with inheritance and multiple sub-properties, function data with dynamic computation, binary arrays of bytes, and mapped data.

4. The method of claim 3, wherein the defining one or more data entities comprises selecting variables from the group consisting of unique system names, entities from whom to inherit properties or assets, and owned properties.

5. The method of claim 1, including defining one or more entity instances by selecting variables from the group consisting of a storage-generated globally unique instance identifier, an entity type name, a definition for authorized access to the defined entity instance, and a defined property value for the entity.

6. The method of claim 5, wherein the defined property value is selected from one or more of first name, date of birth, and address.

7. The method of claim 1, wherein a structure of the one or more guides is defined by selecting variables from the group consisting of a unique system name, a title, a description of the document, a model defining inherited or owned properties, and a list of principals assigned a specific role.

8. The method of claim 7, including defining one or more guide instances by selecting variables from the group consisting of a storage-generated globally unique guide identifier, a guide name, a definition for authorized access to the defined guide instance, and a definition for authorized access to the principals assigned a specific role.

9. The method of claim 1, including defining at least one additional relationship between the one or more defined data entities.

10. The method of claim 3, wherein the providing filtered views of the one or more guides according to the one or more defined relationships comprises selectively restricting or permitting access to one or more of the one or more guides during an engagement timeline.
